(19) United States
(12) Patent Application Publication
(10) Pub. No.: US 2006/0186570 A1
(43) Pub. Date: Aug. 24, 2006

(54) Apparatus of making substrate with surface profile and the method thereof

(75) Inventors: Francis Chung Hwa Pan, Taichung City (TW); John Chungteh Pan, Taichung City (TW); Chun-Chi Lee, Taipei City (TW)

Correspondence Address: BIRCH STEWART KOLASCH & BIRCH, PO BOX 747, FALLS CHURCH, VA, 22040-0747, US

(73) Assignee: Forhouse Corporation

(21) Appl. No.: 11/071,110

(22) Filed: Mar. 4, 2005

(30) Foreign Application Priority Data
Feb. 18, 2005 (TW) 94104947

(51) Int. Cl. B29C 47/06

(52) U.S. Cl. 264/151; 264/171.1; 264/171.13; 425/363; 425/394; 425/308

(57) ABSTRACT

An apparatus for making substrates is consisted of a substrate providing unit, a cooler, a skin layer, a rolling unit and a cutting unit in sequence. The substrate providing unit provides a molten substrate material with a predetermined width. The cooler, which is a conveying unit, solidifies the substrate material and conveys it to the rolling unit. The skin layer providing unit provides a molten skin layer onto the substrate material. The rolling unit rolls the molten skin layer and the solidified substrate material and forms a predetermined surface profile on the skin layer at the same time. The cutting unit cuts the substrate material and the skin layer to have a plurality of the substrates.

### BACKGROUND OF THE INVENTION

1. Field of the Invention

The present invention relates generally to a machine tool, and more particularly to an apparatus of making a substrate with a predetermined surface profile thereon and the method thereof.

2. Description of the Related Art

Conventional methods of molding a composite material include extrusion, injection molding and compression molding etc.

The common method is the injection molding, which the steps thereof include: feeding plastic powder or grains to an injector, in which the plastic is heated, and then the molten plastic is injected into a cavity of a die via a nozzle thereof. After the plastic has been solidified, the die is opened to have a product with a predetermined shape. The advantages of the injection molding are that the product could have complex shape or fine structure, and the drawbacks thereof are that the die for molding large product is expensive and the product usually has residual stress therein.

In the fabrication of a plastic substrate with a predetermined surface profile, such as a light guide plate of the backlight module, the extrusion is applied first to mold a substrate, and then rolling the substrate to have the surface profile while the substrate is still molten. To compare with the injection molding, the process is faster, and there is no residual stress remained. As shown in FIG. 3, while the molten plastic 70 is rolled by two cylinder rollers 72 and 74, a texture 721 on the cylinder roller 72 forms a surface profile 701 on the plastic 70. After rolling, the temperature at opposite sides of the plastic 70 is lower than that of at a core that provide the plastic with a thermal stress T between the opposite sides and the core thereof. The thermal stress T smoothes the surface profile 701 after the plastic 70 has left the rollers 72 and 74, such that the surface profile 701 couldn't have the predetermined slopes, especially when the pattern of the surface profile 701 is very fine.

To have the surface profile with the predetermined slopes, the pressure exerted on the plastic must be increased, and in practice, an interval between the rollers is decreased to increase the pressure. Such solution only applies to a thin film but the substrate with a greater thickness.

### SUMMARY OF THE INVENTION

The primary objective of the present invention is to provide an apparatus and a method of making a substrate with a surface profile, which process is faster, and there is no residual stress remained.

The secondary objective of the present invention is to provide an apparatus and a method of making a substrate with a surface profile, which the surface profile have predetermined slopes.

According to the objectives of the present invention, an apparatus for making substrates has a substrate providing unit, a cooler, a skin layer, a rolling unit and a cutting unit. The substrate providing unit provides a molten substrate material with a predetermined width. The cooler solidifies the substrate material. The skin layer providing unit provides a molten skin layer onto the substrate material. The rolling unit rolls the molten skin layer and the solidified substrate material and forms a predetermined surface profile on the skin layer at the same time. The cutting unit cuts the substrate material and the skin layer to have a plurality of the substrates.

### BRIEF DESCRIPTION OF THE DRAWINGS

FIG. 1 is a sectional view of the apparatus of a preferred embodiment of the present invention;

FIG. 2 is an enlarged view of the apparatus of the preferred embodiment of the present invention, and

FIG. 3 is a sectional view of the conventional rolling apparatus.

### DETAILED DESCRIPTION OF THE INVENTION

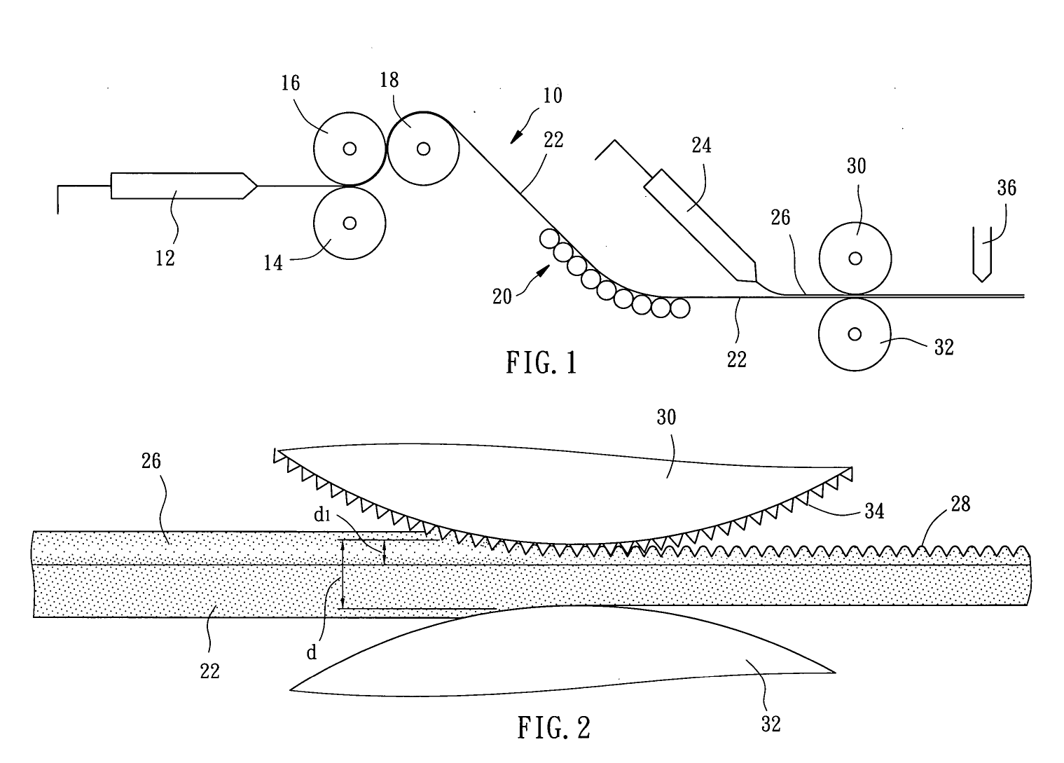

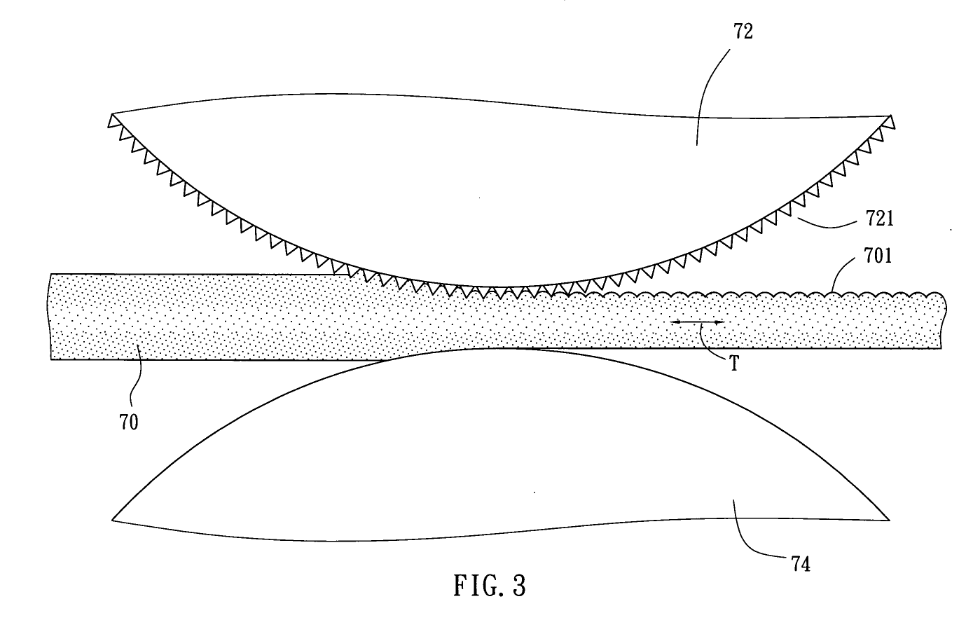

As shown in FIG. 1, an apparatus of the preferred embodiment of the present invention mainly comprises a substrate providing unit 10, a cooler 20, a skin layer providing unit 24, a rolling unit 30, 32 and a cutting unit 36.

The substrate providing unit 10 is to provide an elongated substrate material 22 with a predetermined width, which has an extruder 12 and three cylinder rollers 14, 16 and 18. The extruder 12 provides a molten plastic material, such as polycarbonte (PC), polymethyl methacrylate (PMMA), cyclic olefins polymer (COP) and cyclic olefins copolymer (COC). The rollers 14, 16 and 18 are provided next to the extruder 12 to roll the molten plastic material into a continuous elongated substrate material.

The substrate material is not solidified yet. The cooler 20, which is a conveying unit in the present invention, is located next to the rollers 14, 16 and 18 to rest the substrate material 22 thereon and to convey it to the rolling unit. The temperature of the cooler 20 (about 60° C. to 90° C.) is lower than that of the rollers 14, 16 and 18 (about 80° C. to 150° C.) to solidify the substrate material 22 to a solid (or close to solid) substrate.

The skin layer providing unit 24 is located above the conveyance unit 20 and at a rear section thereof to provide a molten skin layer material 26 on the substrate material 22. In the present invention, the skin layer providing unit 24 is an extruder, and a thickness of the skin layer 22 is much thinner than that of the substrate 22. In practice, the molten skin layer 26 can be coated or printed on the substrate 22 as well.

The rolling unit having two cylinder rollers 30 and 32 is located next to the conveyance unit 20 to roll the substrate material 22 and the skin layer 26 for bonding the skin layer 26 on the substrate 22. The cylinder roller 30 associated with the skin layer 26 has a predetermined texture 34 to form a surface profile 28 on the skin layer 26. The temperature of the rollers 30 and 32 (about 80° C. to 150° C.) is greater than that of the conveyance unit 20.

As shown in FIG. 2, while the solid substrate material 22 and the molten skin layer 26 pass through the rollers 30 and 32, the solid substrate 22 will not be compressed, so that the compression of the roller 32 is exerted on the skin layer 26 through the substrate 22. In other words, the substrate 22 can be taken as an extension of the roller 32, and the real gap of the rolling unit is narrowed to an interval d1 between the roller 30 and the substrate 22 from an interval d between the rollers 30 and 32 that increases the pressure exerted on the skin layer 26. As a result, much pressure is exerted on the skin layer 26 to make the surface profile 28 on the skin layer 26 more closing to the texture 34 of the roller 30.

The cutting unit 36 is located next to the rollers 30 and 32 to cut the substrate material 22 and the skin layer 26, such that a plurality of substrates (not shown) with a predetermined length and with the surface profile are formed.

The substrate material 22 and the skin layer 26 can be made of same material or different materials to have the substrates with a specific optical character or mechanic character. The molten skin layer can be provided to opposite sides of the substrate material (not shown), and both of the skin layers can be rolled to have a surface profile (not shown) thereon respectively.

What is claimed is:

1. An apparatus for making substrates, comprising:
a substrate providing unit providing a molten substrate material with a predetermined width;
a cooler provided next to the substrate providing unit to cool the substrate material;
a skin layer providing unit providing a molten skin layer onto the substrate material;
a rolling unit rolling the molten skin layer and the cooled substrate material, wherein the rolling unit has at least two rollers, and the roller, which rolls the skin layer, has a texture thereon to form a predetermined surface profile on the skin layer, and.
a cutting unit next to the rolling unit cut the substrate material and the skin layer to have a plurality of substrate with the surface profile thereon.

2. The apparatus as defined in claim 1, wherein the substrate providing unit has an extruder for providing the molten substrate material and a plurality of rollers for rolling the molten substrate material.

3. The apparatus as defined in claim 1, wherein the cooler has a conveying unit to rest the substrate material from the substrate providing unit thereon and to convey the substrate material to the rolling unit.

4. The apparatus as defined in claim 2, wherein a temperature of the cooler is lower than that of the rollers of the substrate providing unit.

5. The apparatus as defined in claim 1, wherein a temperature of the cooler is lower than that of the rollers of the rolling unit.

6. The cutter assembly as defined in claim 1, wherein a thickness of the substrate material is greater than that of the skin layer.

7. A method of making a substrate, comprising the steps of:
providing a molten substrate material;
molding the substrate material to have a predetermined width;
cooling the substrate material;
providing a molten skin layer on the substrate material;
rolling the cooled substrate material and the molten skin layer to form a surface profile on the skin layer, and
cutting the substrate material and the skin layer.

8. The method as defined in claim 7, wherein a method of molding the molten substrate material is rolling.

9. The method as defined in claim 7, wherein the molten skin layer is provided to opposite sides of the substrate material.

10. The method as defined in claim 7, wherein a method of providing the skin layer on the substrate is chosen from extrusion, coating and printing.
